(19) United States
(12) Patent Application Publication
(10) Pub. No.: US 2020/0041931 A1
(43) Pub. Date: Feb. 6, 2020

(54) DEVELOPER ACCOMMODATING UNIT, PROCESS CARTRIDGE, AND IMAGE FORMING APPARATUS

(71) Applicant: CANON KABUSHIKI KAISHA, Tokyo (JP)

(72) Inventors: Fumito Nonaka, Mishima-shi (JP); Koji Yamaguchi, Numazu-shi (JP)

(21) Appl. No.: 16/521,816

(22) Filed: Jul. 25, 2019

(30) Foreign Application Priority Data
Jul. 31, 2018 (JP) 2018-143129
Jul. 31, 2018 (JP) 2018-143154

(51) Int. Cl. G03G 15/08; G03G 21/18

(52) U.S. Cl. CPC G03G 15/0881; G03G 21/1814

(57) ABSTRACT

A developer accommodating unit includes a frame that has an opening for discharging a developer, and a sealing unit that has a sealing portion for sealing the opening, in which a state of the sealing unit is capable of changing from a first state in which the sealing portion seals the opening to a second state in which the opening is opened. A tip of a first part is positioned on a downstream side of the base of the first part in a first direction if the sealing unit is in the first state, and the first part is deformed such that the tip of the first part is positioned on an upstream side of the base of the first part in the first direction if the state of the sealing unit changes from the first state to the second state.

### BACKGROUND OF THE INVENTION

### Field of the Invention

The present invention relates to an image forming apparatus, and a developer accommodating unit and a process cartridge used in the image forming apparatus.

### Description of the Related Art

An electrophotographic image forming apparatus (hereinafter referred to as an apparatus main body) that uses a conventional electrophotographic image forming process adopts a process cartridge system in which a process cartridge obtained by integrating an electrophotographic photosensitive member and process means for operating on the electrophotographic photosensitive member is detachable from the apparatus main body. In the process cartridge system described above, an opening portion provided in a developer accommodating frame that accommodates a developer (toner, carrier, or the like) is sealed with a sealing member, and the process cartridge is shipped. When the process cartridge is used, a user peels off a joint portion of a toner seal serving as the sealing member to open the opening portion, and supply of the developer to the apparatus main body is allowed.

In recent years, Japanese Patent Application Publication No. 2014-167606 describes a configuration in which, in order to reduce a burden of a user, an opening is automatically opened by a driving force of an apparatus main body after a process cartridge is attached to the apparatus main body. In the configuration described in Japanese Patent Application Publication No. 2014-167606, a sealing member is peelably fixed to a developer container along the edge of the opening by thermal welding or the like. When a rotating member in the developer container for containing the developer rotates, the sealing member is wound around the rotating member, and the opening of the developer container is opened.

On the other hand, in a configuration described in Japanese Patent Application Publication No. 2013-134401, a sealing material is disposed between the outer peripheral surface of a shutter for opening and closing an opening portion of a toner cartridge and the inner peripheral surface of the toner cartridge, and the toner cartridge is opened by rotating the shutter. The shutter closes the opening portion in a state in which the sealing material is compressed by the shutter.

In the case of a compressed seal, an unsealing operation is started in a state in which the seal is compressed when opening is performed, and hence specific force is required.

### SUMMARY OF THE INVENTION

An object of the present invention is to improve sealing performance of a seal while reducing an unsealing load of a compressed seal.

In order to achieve the object described above, a developer accommodating unit according to the present invention including:

a frame provided with a developer accommodating chamber configured to accommodate a developer, and an opening for discharging the developer from the developer accommodating chamber; and a sealing unit provided inside the frame, the sealing unit including a supporting portion rotatable in a first direction, and a sealing portion attached to the supporting portion, the sealing portion sealing the opening, the sealing portion having a protruding portion including a first part, the protruding portion being capable of coming into contact with the frame in a surrounding part of the opening, a state of the sealing unit being capable of changing from a first state in which the sealing portion seals the opening to a second state in which the opening is opened, wherein if the sealing unit is in the first state, a tip of the first part is positioned on a downstream side of a base of the first part in the first direction, and wherein if the state of the sealing unit changes from the first state to the second state, the first part is deformed such that the tip of the first part is positioned on an upstream side of the base of the first part in the first direction.

In order to achieve the object described above, a developer accommodating unit according to the present invention including:

a frame provided with a developer accommodating chamber configured to accommodate a developer, and an opening for discharging the developer from the developer accommodating chamber; and a sealing unit provided inside the frame, the sealing unit including a supporting portion rotatable in a first direction, and a sealing portion attached to the supporting portion, the sealing portion sealing the opening by being compressed by the frame and the supporting portion, the sealing portion having a protruding portion including a first part and a second part, the protruding portion being capable of coming into contact with the frame in a surrounding part of the opening, a state of the sealing unit being capable of changing from a first state in which the sealing portion seals the opening to a second state in which the opening is opened, wherein if the sealing unit is in the first state, the first part comes into contact with the frame on a downstream side of the opening in the first direction and is inclined from a base of the first part toward a tip of the first part in a direction from an upstream side of the opening toward the downstream side of the opening, and the second part comes into contact with the frame on the upstream side of the opening in the first direction and is inclined from a base of the second part toward a tip of the second part in a direction from the downstream side of the opening toward the upstream side of the opening, and a length from the base of the first part to the tip of the first part is greater than a thickness of the first part, and a length from the base of the second part to the tip of the second part is greater than a thickness of the second part when viewed in a direction of a rotational axis of the supporting portion.

Further features of the present invention will become apparent from the following description of exemplary embodiments (with reference to the attached drawings).

### BRIEF DESCRIPTION OF THE DRAWINGS

FIG. 1 is a cross-sectional view of a process cartridge having a developer accommodating unit in an embodiment;

FIG. 2 is a cross-sectional view of an image forming apparatus in the embodiment;

FIG. 3 is a cross-sectional view of the developer accommodating unit in the embodiment when viewed from a lateral direction of the developer accommodating unit;

FIG. 4 is a perspective view illustrating assembly of the developer accommodating unit in the embodiment;

FIGS. 5A and 5B are perspective views of a sealing unit in the embodiment;

FIGS. 6A to 6E are cross-sectional views of the sealing unit in the embodiment;

FIG. 7 is a perspective view of a driving portion of the sealing unit in the embodiment;

FIG. 8 is a perspective view of an unsealing gear in the embodiment;

FIGS. 9A and 9B are perspective views of an intermediate gear in the embodiment;

FIGS. 10A to 10F are views for explaining the operation of the sealing unit in the embodiment:

FIG. 11 is a cross-sectional view of a sealing unit in a comparative example;

FIGS. 12A and 12B are cross-sectional views of the sealing unit in the embodiment; and

FIG. 13 is a cross-sectional view of the sealing unit in the embodiment.

### DESCRIPTION OF THE EMBODIMENTS

Embodiments of the present invention will now be described with reference to the drawings. Dimensions, materials, shapes of the components and the relative positions thereof described in the embodiments may be appropriately changed depending on the configuration of an apparatus to which the present invention is applied, and on various conditions, and are not intended to limit the scope of the invention to the following embodiments.

An image forming apparatus forms an image on a recording medium by using, e.g., an electrophotographic image forming process, and examples of the image forming apparatus include an electrophotographic copier, an electrophotographic printer (e.g., an LED printer, a laser beam printer, or the like), and an electrophotographic facsimile machine. A cartridge denotes a cartridge in which at least developing means and a developing apparatus that accommodates a developer are integrally configured and which is made detachable from an image forming apparatus main body, and a cartridge in which the developing apparatus and a photosensitive member unit having at least a photosensitive member are integrally configured and which is made detachable from the image forming apparatus main body.

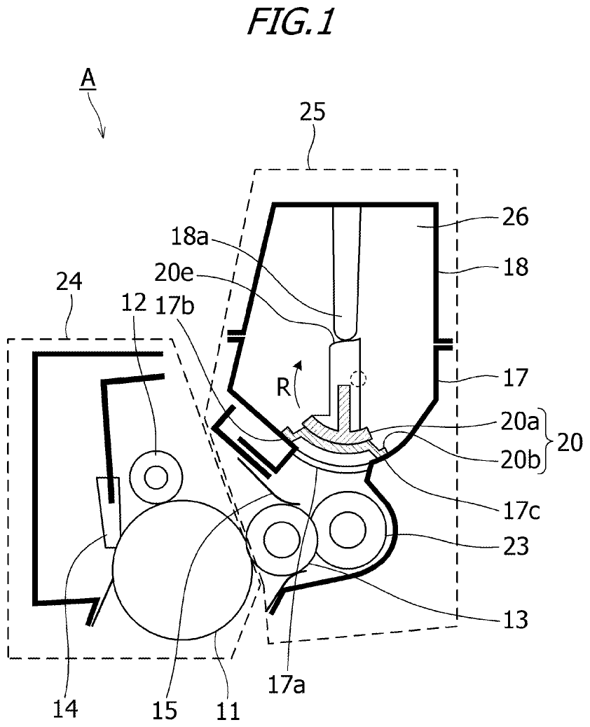

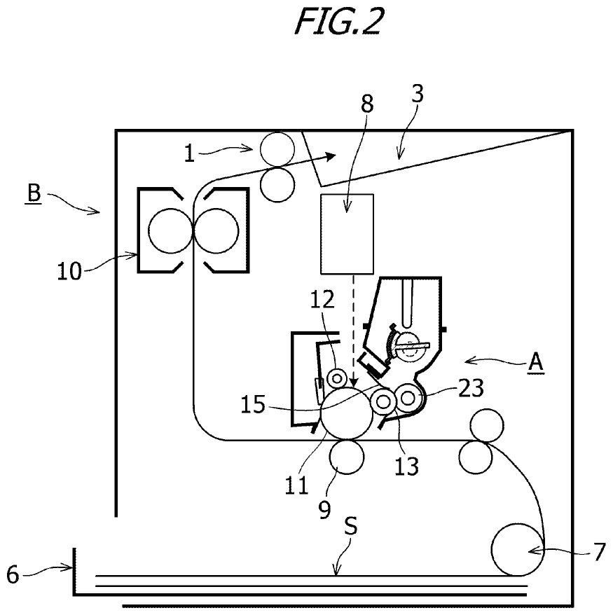

FIG. 1 is a cross-sectional view of a process cartridge having a developer accommodating unit to which the present invention can be applied, and FIG. 2 is a cross-sectional view of an image forming apparatus to which the present invention can be applied.

Outline of Configuration of Process Cartridge

The process cartridge includes an image bearing member and process means for operating on the image bearing member. Examples of the process means include charging means for charging the surface of the image bearing member, a developing apparatus for forming an image on the image bearing member, and cleaning means for removing a developer (including toner and carrier) remaining on the surface of the image bearing member. As illustrated in FIG. 1, a process cartridge A of the present embodiment includes a cleaner unit 24. The cleaner unit 24 has a photosensitive drum 11 serving as the image bearing member, a charging roller 12 serving as the charging means, and a cleaning blade 14 that has elasticity and serves as the cleaning means. The charging roller 12 and the cleaning blade 14 are disposed around the photosensitive drum 11. In addition, the process cartridge A includes a developer accommodating unit 25 having a first frame 17 and a second frame 18. The process cartridge A is configured such that the cleaner unit 24 and the developer accommodating unit 25 are integrated with each other and, as illustrated in FIG. 2, the process cartridge A is detachable from an image forming apparatus main body B. The developer accommodating unit 25 includes a developing roller 13 serving as the developing means, a developing blade 15, a supply roller 23, and a developer accommodating chamber 26 that accommodates the developer. The developing roller 13 and the developing blade 15 are supported by the first frame 17.

Outline of Configuration of Image Forming Apparatus

The process cartridge A is attached to the image forming apparatus main body B illustrated in FIG. 2, and is used for image formation. In the image formation, a sheet (recording material) S is transported from a sheet cassette 6 attached to the lower part of the image forming apparatus main body B by a transport roller 7, the photosensitive drum 11 is selectively exposed by an exposure apparatus 8 in synchronization with the sheet transport, and a latent image is formed on the photosensitive drum 11. The developer is supplied to the developing roller (developer carrying member) 13 by the spongy supply roller 23, and the developing blade 15 causes the surface of the developing roller 13 to carry a thin layer of the developer. By applying a developing bias to the developing roller 13 and supplying the developer in accordance with the latent image, the latent image is developed into a developer image. With this, the developer image is formed on the photosensitive drum 11, and the photosensitive drum 11 bears the developer image. The developer image on the photosensitive drum 11 is transferred to the sheet S by applying a bias voltage to a transfer roller (transfer portion) 9. The sheet S is transported to a fixing apparatus 10, and the image is fixed to the sheet S by the fixing apparatus 10. The sheet S is discharged to a sheet discharge portion 3 in the upper part of the image forming apparatus main body B by a sheet discharge roller 1.

Configuration of Developer Accommodating Unit

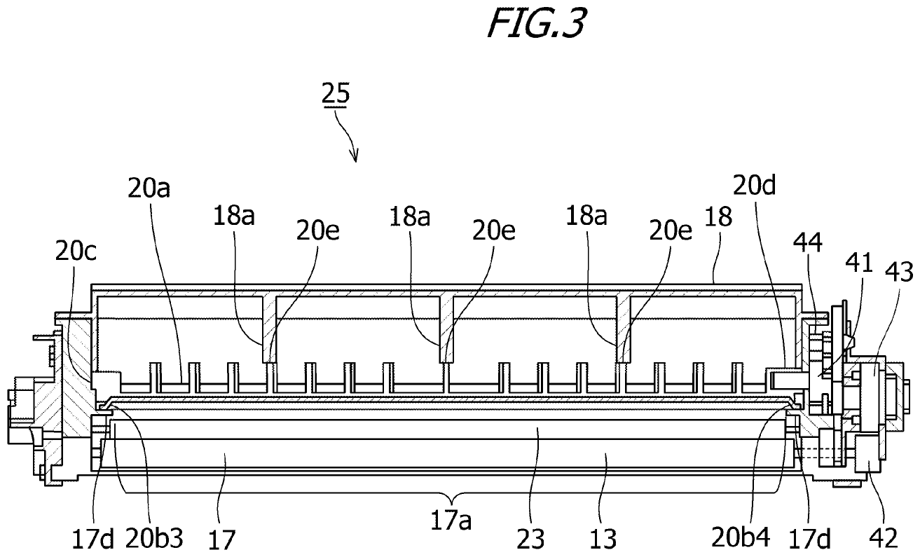

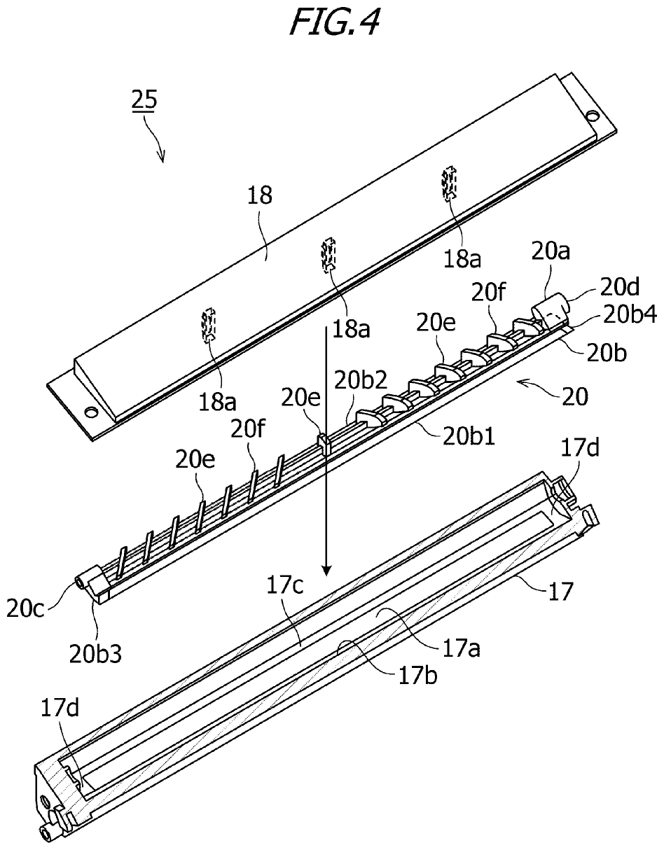

Next, the configuration of the developer accommodating unit 25 will be described by using FIG. 1, FIG. 3, and FIG. 4. FIG. 3 is a cross-sectional view in which the developer accommodating unit 25 is cut along the axis of the developing roller 13, i.e., a cross-sectional view of the developer accommodating unit 25 when viewed from a lateral direction of the developer accommodating unit 25. FIG. 4 is a perspective view illustrating assembly of the developer accommodating unit 25. Note that, in the following description, an axial direction of the developing roller 13 is defined as a longitudinal direction, and a direction orthogonal to the longitudinal direction is defined as a lateral direction. As illustrated in FIG. 1, in the developer accommodating unit 25, the first frame 17 that supports the developing roller 13 and the developing blade 15 and the second frame 18 are integrated with each other to constitute one developing frame (frame). The first frame 17 and the second frame 18 form the developer accommodating chamber 26 inside the developer accommodating unit 25. An opening 17a for discharging toner accommodated in the developer accommodating chamber 26 is provided in the lower part of the first frame 17 over a wide area in the longitudinal direction. In other words, the developing frame described above includes the developer accommodating chamber 26 and the opening 17a.

A sealing unit 20 for sealing the opening 17a is provided inside the developer accommodating chamber 26. In FIG. 1, the sealing unit 20 is provided inside the first frame 17. The sealing unit 20 is formed to extend in the longitudinal direction along the opening 17a, and a sealing portion 20b that has elasticity and a supporting portion 20a that supports the supporting portion 20b are integrally coupled to each other. As illustrated in FIG. 3, shaft portions 20c and 20d are provided at both ends of the supporting portion 20a, and the sealing unit 20 (the supporting portion 20a) is rotatably supported by the first frame 17. In addition, an unsealing gear 41 is coupled to the shaft portion 20d at one end (the right side in FIG. 3), and the sealing unit 20 and the unsealing gear 41 rotate integrally. Further, the unsealing gear 41 is engaged with an input gear 43 via an intermediate gear 44. When the process cartridge A is shipped, as illustrated in FIG. 1, the sealing unit 20 is disposed at a position that allows the sealing unit 20 to seal the opening 17a using the sealing portion 20b. When the process cartridge A is used, the input gear 43 is given drive from the image forming apparatus main body B to rotate, whereby the sealing unit 20 rotates in a direction of an arrow R in FIG. 1, and the opening 17a is opened. A state in which the sealing unit 20 (the sealing portion 20b) seals the opening 17a is referred to as a sealing state or a first state. When the sealing unit 20 is in the sealing state, the discharge of the toner from the opening 17a is prevented. In addition, a state in which the sealing unit 20 (the sealing portion 20b) is at a position that allows the opening 17a to be exposed is referred to as an unsealing state or a second state. When the sealing unit 20 is in the unsealing state, the opening 17a is opened. The discharge of the toner from the opening 17a is permitted. The supporting portion 20a can rotate about an axis (rotational axis) g described later. A direction in which the supporting portion 20a rotates such that a state of the sealing unit 20 changes from the sealing state to the unsealing state is referred to as an unsealing direction or a first direction (rotation direction R). Note that, after the sealing unit 20 is brought into the unsealing state, the sealing unit 20 can repeatedly move in a direction opposite to the rotation direction R (second direction) and in the rotation direction R in a range that does not allow the sealing unit 20 to seal the opening 17a. That is, after the sealing unit 20 is brought into the unsealing state, the sealing unit 20 can perform back-and-forth movement. The configuration of the sealing unit 20 will be described later in detail.

The developing roller 13 and the supply roller 23 for supplying the toner to the developing roller 13 are provided outside the developer accommodating chamber 26. Both ends of each of the developing roller 13 and the supply roller 23 in the longitudinal direction are rotatably supported by the first frame 17. A developing gear 42 is coupled to one end of the developing roller 13 in the longitudinal direction, and the developing gear 42 is engaged with the input gear 43. A gear that is not illustrated is coupled to one end of the supply roller 23 in the longitudinal direction, and the gear that is not illustrated is engaged with the input gear 43. With the rotation of the input gear 43, the developing roller 13 and the supply roller 23 rotate together with the unsealing gear 41. In addition, as illustrated in FIGS. 3 and 4, a plurality of rib-like pressing portions 18a protrude toward the opening 17a (downward in FIGS. 3 and 4) from the inner top surface of the second frame 18. Each pressing portion 18a is provided at a position that is inside the second frame 18 and faces the opening surface of the opening 17a, and comes into contact with a pressed portion 20e provided in the sealing unit 20 in the sealing state. The sealing portion 20b is attached to the supporting portion 20a and is held between the first frame 17 and the supporting portion 20a to thereby seal the opening 17a. In other words, the sealing portion 20b is pressed against the surrounding part of the opening 17a in the first frame 17 and is compressed by the supporting portion 20a. That is, the sealing portion 20b is compressed by the supporting portion 20a and the first frame 17. Subsequently, the opening 17a is sealed by the sealing portion 20b. That is, the sealing portion 20b can come into contact with the first frame 17 in the surrounding part of the opening 17a. The sealing state denotes a state in which the sealing unit 20 seals the opening 17a. The function of the pressing portion 18a will be described later.

Detailed Configuration of Sealing Unit 20

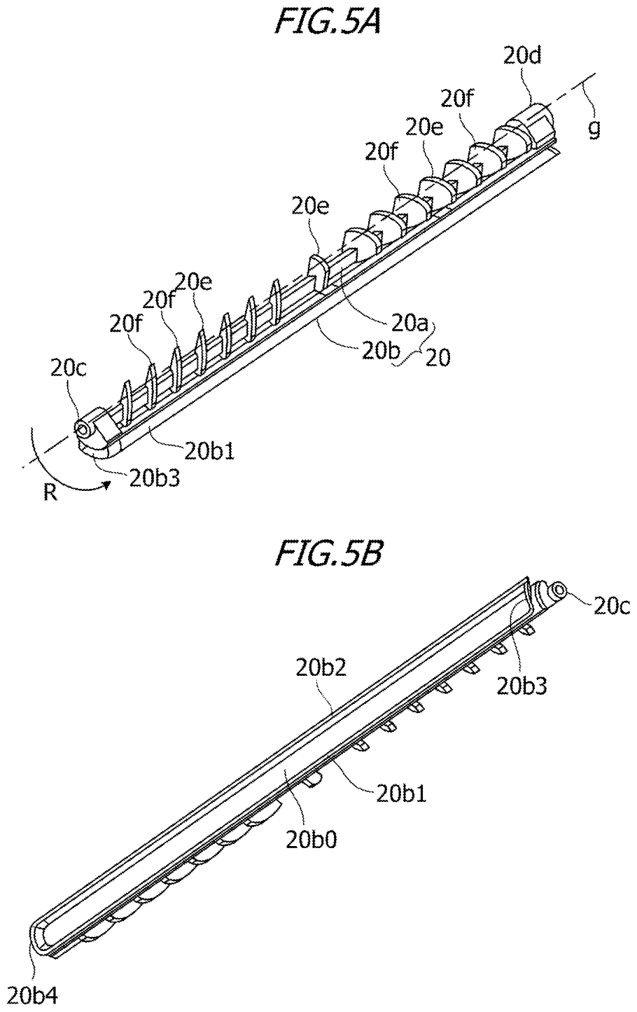

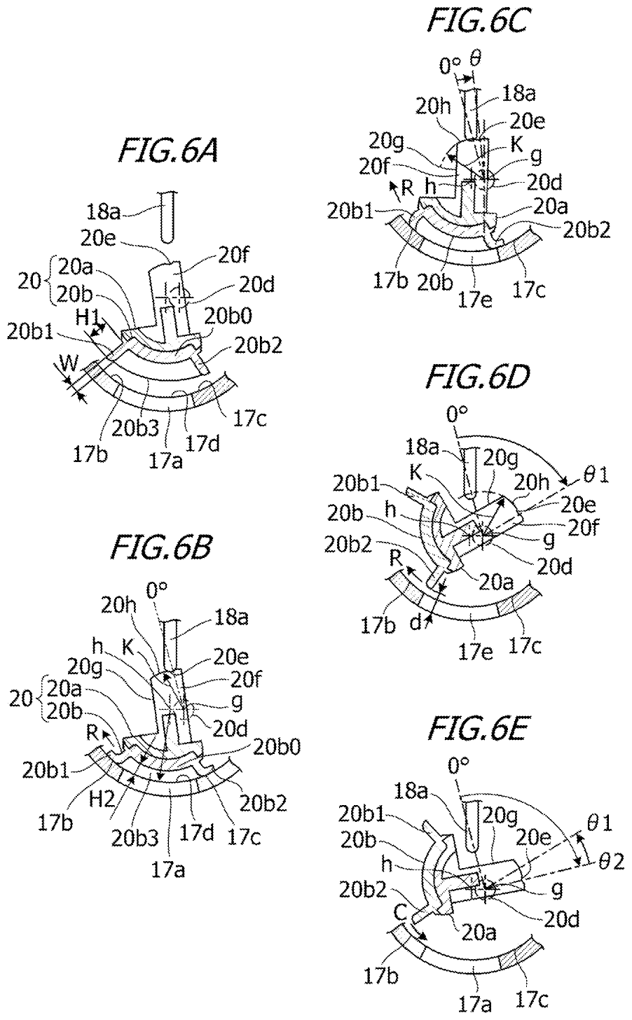

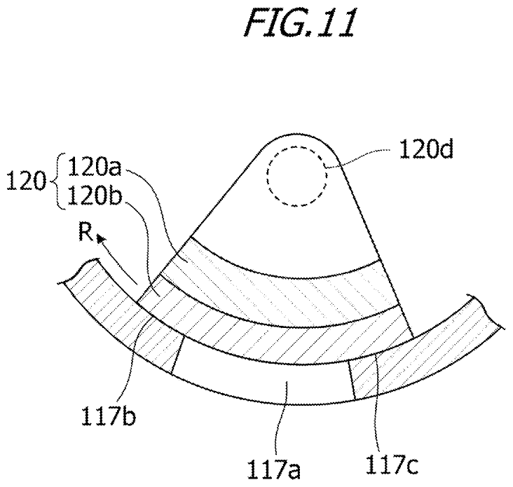

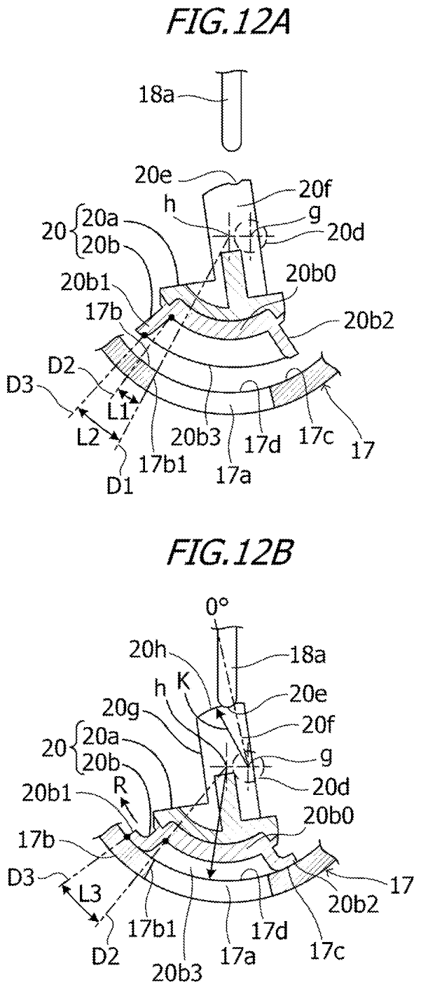

Next, the detailed configuration of the sealing unit 20 will be described by using FIG. 4, FIGS. 5A and 5B, FIGS. 6A to 6E, FIG. 11, and FIGS. 12A and 12B. FIGS. 5A and 5B are perspective views of the sealing unit 20, and FIGS. 6A to 6E and FIGS. 12A and 12B are cross-sectional views of the sealing unit 20. FIG. 6A illustrates a state before the sealing unit 20 is incorporated in the developer accommodating chamber 26, and FIG. 6B illustrates a state in which the sealing unit 20 is incorporated in the developer accommodating chamber 26. FIGS. 6C to 6E are views for explaining the unsealing operation of the sealing unit 20. FIG. 11 is a cross-sectional view of a sealing unit 120 in a comparative example. FIG. 12A is a view obtained by enlarging FIG. 6A and adding dimensions to FIG. 6A for explanation. Similarly, FIG. 12B is a view obtained by enlarging FIG. 6B and adding dimensions to FIG. 6B. As described above, the sealing unit 20 includes the supporting portion 20a and the sealing portion 20b having elasticity. In the present embodiment, an elastomer resin is used as the material of the sealing portion 20b, and a polystyrene resin is used as the material of the supporting portion 20a. In this case, the rigidity of the sealing portion 20b is lower than the rigidity of the supporting portion 20a. With regard to a manufacturing method thereof, the sealing portion 20b and the supporting portion 20a may be manufactured separately and joined to each other, and the supporting portion 20a and the sealing portion 20b may also be formed integrally by using the elastomer resin as the material of the supporting portion 20b. The step of joining the two members becomes unnecessary by integrally forming the supporting portion 20a and the sealing portion 20b, and it is possible to achieve an improvement in productivity. The material of the sealing portion 20b is not limited to the elastomer resin. Another elastic material may be used as the material of the sealing portion 20h, and the material thereof is not limited to the elastomer resin as long as the material is properly shaped and set such that sealability for the toner in a container is maintained and a load for unsealing does not become higher than a conventional load, as will be described later.

Next, the shape of the sealing portion 20b will be described in detail. The sealing portion 20b has a base portion 20b0, and a protruding portion including lips 20b1 to 20b4. When the sealing unit 20 is in the sealing state, the protruding portion of the sealing portion 20b comes into contact with the first frame 17 in the surrounding part of the opening 17a. As illustrated in FIG. 5B, in the sealing portion 20b the lips 20b1 to 20b4 that linearly protrude from the slender rectangular base portion 20b0 are formed to extend along the peripheral part of the base portion 20b0. That is, the lips 20b1 to 20b4 are provided to stand on the peripheral part of the base portion 20b0, and a frame member is formed in the peripheral part of the base portion 20b0 by the lips 20b1 to 20b4. The lips 20b1 to 20b4 protrude from the base portion 20b0 to a side opposite to the side of the supporting portion 20a. The upper surface of the base portion 20b0 is a joint surface that is joined to the supporting portion 20a. In the rotation direction R, the lip 20b1 is positioned on a downstream side of the lip 20b2. The lip 20b1 and the lip 20b2 extend in a direction of the rotational axis (the axis g) of the supporting portion 20a. That is, the longitudinal direction of each of the lip 20b1 and the lip 20b2 matches the direction of the rotational axis (the axis g) of the supporting portion 20a. The lip 20b3 and the lip 20b4 extend in a direction (the rotation direction of the supporting portion 20a) intersecting the rotational axis (the axis g) of the supporting portion 20a. That is, the longitudinal direction of each of the lip 20b3 and the lip 20b4 matches the direction (the rotation direction of the supporting portion 20a) intersecting the rotational axis (the axis g) of the supporting portion 20a. Each of the inner surfaces of the lips 20b1 to 20b4 faces the inner direction of the base portion 20b0. Each of the outer surfaces of the lips 20b1 to 20b4 faces the outer direction of the base portion 20b0. The inner surface of the lip 20b1 and the inner surface of the lip 20b2 face each other, and the inner surface of the lip 20b3 and the inner surface of the lip 20b4 face each other. In the case of the sealing state, as illustrated in FIG. 6B, the lips 20b1 to 20b4 are disposed so as to surround the periphery of the opening 17a. That is, in the case of the sealing state, the supporting portion 20a biases the lips 20b1 to 20b4 toward the surrounding part of the opening 17a in the first frame 17, and the lips 20b1 to 20b4 come into contact with the surrounding part of the opening 17a in the first frame 17. When the sealing unit 20 is in the sealing state, in the rotation direction R, the tip of the lip 20b1 (a first part) is positioned on the downstream side of the base of the lip 20b1, and the tip of the lip 20b2 (a second part) is positioned on an upstream side of the base of the lip 20b2. In the sealing state, the lips 20b1 and 20b2 disposed on the long sides of the base portion 20b0 are deformed into shapes conforming to arc shapes of contacted portions 17b and 17c of the first frame 17. In addition, in the sealing state, each of the lips 20b3 and 20b4 disposed on the short sides of the base portion 20b0 is deformed into a shape conforming to an arc shape of a contacted portion 17d of the first frame 17. The contacted portions 17b, 17c, and 17d are inner parts of the first frame 17, and are included in the surrounding part of the opening 17a in the first frame 17.

With regard to cross-sectional dimensions of each of the lips 20b1 to 20b4, as illustrated in FIG. 6A, for example, a height H1 is 2.8 mm, and a width W is 1 mm. In the case where the sealing unit 20 is in the sealing state (FIG. 6B), the sealing portion 20b deforms and the sealing unit 20 is supported by the first frame 17. For example, a distance H2 between the base portion 20b0 of the sealing portion 20b and the opening 17a at this point is 2.1 mm. The sealing portion 20b deforms, and H1>H2 is thereby satisfied.

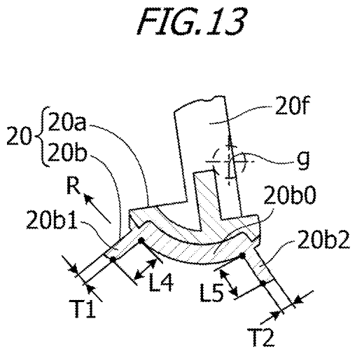

The tip shape of each of the lips 20b1 to 20b4 will be specifically described by using FIGS. 12A and 12B and FIG. 13. A distance L1 from a line D1 passing through an end surface 17d1 of the opening 17a to a line D2 passing through the base of the lip 20b1 is less than a distance L2 from the line D1 passing through the end surface 17b1 to a line D3 passing through the tip of the lip 20b1. That is, the lip 20b1 is provided in the base portion 20b0 such that the distance L1<the distance L2 is satisfied. The same applies to each of the lips 20b2 to 20b4. The base of the lip 20b1 is a boundary part between the base portion 20b0 and the lip 20b1. The line D2 is a line drawn from the base of the lip 20b1 to the contacted portion 17b of the first frame 17. The line D3 is a line drawn from the tip of the lip 20b1 to the contacted portion 17b of the first frame 17. The distance L2 is greater than the distance L1. Consequently, the lip 20b1 is inclined toward the outer side of the base portion 20b0. Similarly, the lips 20b2 to 20b4 are inclined toward the outer side of the base portion 20b0.

As illustrated in FIG. 12B, the sealing unit 20 is incorporated in the developer accommodating chamber 26. In the state in which the sealing portion 20b seals the opening 17a, the tip of the lip 20b1 is in contact with the contacted portion 17b, and the tip of the lip 20b2 is in contact with the contacted portion 17c. That is, when the sealing unit 20 is in the sealing state, in the rotation direction R, the lip 20b1 comes into contact with the first frame 17 on the downstream side of the opening 17a. In the rotation direction R, the lip 20b2 comes into contact with the first frame 17 on the upstream side of the opening 17a. At this point, the supporting portion 20a is pressed by the pressing portion 18a, and the lips 20b1 to 20b4 are deformed. In this case, the lip 20b1 is inclined from the base of the lip 20b1 toward the tip thereof in a direction from the upstream side of the opening 17a toward the downstream side thereof. In addition, the lip 20b2 is inclined from the base of the lip 20b2 toward the tip thereof in a direction from the downstream side of the opening 17a toward the upstream side thereof. The upstream side of the opening 17a matches the upstream side of the sealing unit 20 in the rotation direction. The downstream side of the opening 17a matches the downstream side of the sealing unit 20 in the rotation direction.

The lip 20b1 is inclined in a direction in which the tip of the lip 20b1 moves away from the opening 17a further as compared with the position of the tip of the lip 20b1 in the state (FIG. 12A) before the tip of the lip 20b1 comes into contact with the contacted portion 17b. In other words, a distance L3 between the line D2 and the line D3 in the lip 20b1 in FIG. 12B is greater than a distance (L2−L1) between the line D2 and the line D3 in the lip 20b1 in FIG. 12A. That is, when the sealing unit 20 is incorporated in the developer accommodating chamber 26, the lip 20b1 comes into contact with the contacted portion 17b in a state in which the tip of the lip 20b1, which is inclined before the sealing unit 20 is incorporated in the developer accommodating chamber 26, is bent in a specific direction. In other words, part of the inner surface of the lip 20b1 comes into contact with the surrounding part of the opening 17a in the first frame 17, and part of the inner surface of the lip 20b2 comes into contact with the surrounding part of the opening 17a in the first frame 17. This deformation takes place over the entire periphery of the sealing portion 20b, and the lips 20b1 to 20b4 come into contact with the surrounding part of the opening 17a in the first frame 17 in a state in which each of the tips of the lips 20b1 to 20b4 is bent in a direction away from the opening 17a.

As illustrated in FIG. 13, when viewed in the direction of the rotational axis (the axis g) of the supporting portion 20a, a length L4 from the base of the lip 20b1 to the tip thereof is greater than a thickness T1 of the lip 20b1, and a length L5 from the base of the lip 20b2 to the tip thereof is greater than a thickness T2 of the lip 20b2. Note that viewing in the direction of the rotational axis (the axis g) denotes that an object projected on a plane orthogonal to the rotational axis (the axis g) is viewed along the direction of the rotational axis. Accordingly, the lip 20b1 and the lip 20b2 are easily bent in the rotation direction R of the sealing unit 20. In the present embodiment, the length L4, the thickness T1, the length L5, and the thickness T2 are measured in the following manner. In a protruding direction of the lip 20b1, the length of a part of the lip 20b1 that protrudes from the base portion 20b0 is the length L4 from the base of the lip 20b1 to the tip thereof. In a direction that is orthogonal to the protruding direction of the lip 20b1 and extends along the rotation direction R of the sealing unit 20, a distance between the outer surface of the lip 20b1 and the inner surface opposite to the outer surface is the thickness T1 of the lip 20b1. In a protruding direction of the lip 20b2, the length of a part of the lip 20b2 that protrudes from the base portion 20b0 is the length L5 from the base of the lip 20b2 to the tip thereof. In a direction that is orthogonal to the protruding direction of the lip 20b2 and extends along the rotation direction R of the sealing unit 20, a distance between the outer surface of the lip 20b2 and the inner surface opposite to the outer surface is the thickness T2 of the lip 20b2.

In the configuration of the embodiment, the lip 20b1 is provided in the base portion 20b0 such that the length L4 from the base of the lip 20b1 to the tip thereof is greater than the thickness T1 of the lip 20b1. In addition, in the configuration of the embodiment, the lip 20b2 is provided in the base portion 20b0 such that the length L5 from the base of the lip 20b2 to the tip thereof is greater than the thickness T2 of the lip 20b2. Each of the lip 20b3 and the lip 20b4 also has a shape in which the length is greater than the thickness. A thickness direction of each of the lip 20b3 and the lip 20b4 matches the direction of the rotational axis of the supporting portion 20a. With this, the lip 20b1 and the lip 20b2 are easily bent, and hence, even in the case where the pressure of the sealing portion 20b that biases the surrounding part of the opening 17a in the first frame 17 is low, the sealing state is maintained. By reducing the biasing pressure applied to the surrounding part of the opening 17a in the first frame 17, it is possible to reduce a load when the opening 17a is opened. Consequently, it is possible to improve the sealing performance of the sealing unit 20 while reducing the unsealing load of the compressed sealing unit 20. In addition, since the lip 20b1 and the lip 20b2 are easily bent in the rotation direction R of the sealing unit 20, the sealing unit 20 can rotate in the state in which the lip 20b1 and the lip 20b2 are bent, and the load when the opening 17a is opened is reduced. Note that, in the case where the thickness T1 of the lip 20b1 is greater than the length L4 from the base of the lip 20b1 to the tip thereof, the lip 20b1 is not easily bent in the rotation direction R of the sealing unit 20. In addition, in the case where the thickness 12 of the lip 20b2 is greater than the length L5 from the base of the lip 20b2 to the tip thereof, the lip 20b2 is not easily bent in the rotation direction R of the sealing unit 20.

In the case where the distance L1 between the line D1 and the line D2 is equal to the distance L2 between the line D1 and the line D3 (L1=L2), the direction of bend of the lip 20b1 is not stabilized when the sealing unit 20 is incorporated in the developer accommodating chamber 26. In the case where the lips 20b1 to 20b4 are bent nonuniformly, it is feared that the toner may leak from a gap between the lips 20b1 to 20b4 and the surrounding part of the opening 17a in the first frame 17. In addition, in the embodiment, each of the tips of the lips 20b1 to 20b4 faces a direction away from the opening 17a, i.e., a direction of an accommodation area of the toner. The individual tips of the lips 20b1 to 20b4 of the sealing portion 20b are pressed against the contacted portions 17b, 17c, and 17d by toner powder pressure in the developer accommodating chamber 26, and hence the sealing performance is more excellent than that of the configuration in which each of the tips of the lips 20b1 to 20b4 faces a direction approaching the opening 17a. Note that each of corner portions at which the lips 20b1 and 20b2 disposed on the long sides of the base portion 20b0 intersect the lips 20b3 and 20b4 disposed on the short sides of the base portion 20b0 has an arc shape (FIG. 5B).

With the foregoing, the sealing portion 20b is held between the contacted portions 17b, 17c, and 17d (FIG. 4) of the entire periphery of the opening 17a and the supporting portion 20a, and the directions in which the lips 20b1 to 20b4 are bent are constant due to the contact of the sealing portion 20b with the contacted portions 17b, 17c, and 17d. Accordingly, the sealing state is stably maintained.

In addition, as illustrated in FIG. 6A, in the supporting portion 20a, the pressed portion 20e is provided at a position that is on a side opposite to the side of the sealing portion 20b and faces the pressing portion 18a. The pressing portion 18a comes into contact with the pressed portion 20e, the sealing portion 20b slightly deforms, and the sealing unit 20 maintains the sealing state (FIG. 6B). That is, in the case where the pressed portion 20e comes into contact with the pressing portion 18a, the lips 20b1 to 20b4 come into contact with the surrounding part of the opening 17a in the first frame 17 in a state in which the shapes of the lips 20h1 to 20b4 are deformed. With this, the supporting portion 20a is warped due to the elasticity of the sealing portion 20b, and the sealing performance can be thereby prevented from being reduced. In addition, it is possible to prevent leakage of the toner from the opening 17a caused by the deformation of the sealing unit 20 that results from vibrations or the like during distribution. Further, by providing the pressing portion 18a in the second frame 18, the bending rigidity of the supporting portion 20a can be reduced to a level lower than that in the case where the pressing portion 18a is not provided in the second frame 18. In addition, the provision of the pressing portion 18a in the second frame 18 contributes to saving of the material of the supporting portion 20a and a reduction in the weight of the supporting portion 20a. Note that, with regard to the number of the pressing portions 18a, in the embodiment, the pressing portions 18a are provided at three places in the second frame 18, but the number of the pressing portions 18a may be appropriately selected according to the rigidity of the supporting portion 20a and the elasticity of the sealing portion 20b. The number of the pressed portions 20e is selected according to the number of the pressing portions 18a.

When the sealing unit 20 receives the drive from the image forming apparatus main body B, as illustrated in FIG. 6B, the sealing unit 20 rotates in the direction of the arrow R about the axis g joining the shaft portions 20c and 20d at both ends. Herein, the sealing unit 120 in the comparative example in FIG. 11 will be described. The sealing unit 120 in the comparative example includes a supporting portion 120a and a rectangular sponge 120b, and the sponge 120b covers an opening 117a. The sealing unit 120 is rotatably supported via a shaft portion 120d. In the comparative example, when the unsealing of the opening 117a is started, the sponge 120b slides on and rubs against contacted portions 117b and 117c while maintaining a compressed state. In contrast, in the configuration of the sealing unit 20 in the embodiment, as illustrated in FIG. 6C, the tip of the lip 20b1 on the downstream side in the rotation direction R is inverted inwardly without sliding from the position where the tip thereof is in contact with the contacted portion 17b. That is, when a state of the sealing unit 20 changes from the sealing state to the unsealing state, the tip of the lip 20b1 is positioned on the upstream side of the base of the lip 20b1 in the rotation direction R of the sealing unit 20, and the tip of the lip 20b2 is positioned on the upstream side of the base of the lip 20b2 in the rotation direction R of the sealing unit 20. In other words, when a state of the sealing unit 20 changes from the sealing state to the unsealing state, the lip 20b1 is deformed such that the tip of the lip 20b1 is positioned on the upstream side of the base of the lip 20b1 in the rotation direction R. On the other hand, when a state of the sealing unit 20 changes from the sealing state to the unsealing state, the tip of the lip 20b2 is positioned on the upstream side of the base of the lip 20b2 in the rotation direction R. That is, the inclination direction of the lip 20b2 does not change. The unsealing state denotes a state in which the sealing unit 20 opens the opening 17a. In this case, part of the outer surface of the lip 20b1 comes into contact with the surrounding part of the opening 17a in the first frame 17, and part of the inner surface of the lip 20b2 comes into contact with the surrounding part of the opening 17a in the first frame 17. Thereafter, the lip 20b1 slides while being inverted inwardly. Consequently, according to the configuration of the embodiment, the load of the unsealing can be made lower than that in the configuration of the comparative example in which the rectangular sponge 120b is used. As described above, the lip 20b1 and the lip 20b2 are easily bent in the rotation direction R of the sealing unit 20, and hence, even in the case where the tip of the lip 20b1 is not inverted inwardly, the load of the unsealing in the configuration of the embodiment is lower than that in the configuration of the comparative example in which the rectangular sponge 120b is used. In addition, in the configuration of the embodiment, the toner is easily transported especially by the lip 20b1 and the lip 20b2.

On the surface of the pressed portion 20e that is in contact with the pressing portion 18a, a concave arc shape conforming to a convex arc shape of the pressing portion 18a is formed. In addition, on the surface of the pressed portion 20e that is in contact with the pressing portion 18a, a concave shape conforming to a convex shape of the pressing portion 18a may be formed. With this configuration, the phase of the sealing unit 20 is stabilized when the sealing unit 20 is assembled. In addition, it is possible to prevent the sealing unit 20 from moving in a circumferential direction due to vibrations or the like during distribution. A recess portion 20g that is retracted inwardly of a radius of rotation K of the pressed portion 20e is disposed on the upstream side of the pressed portion 20e in the rotation direction R. That is, the sealing unit 20 has a depressed portion that is provided within the radius of rotation K of the pressed portion 20e. In the case where the sealing unit 20 rotates in the direction of the arrow R, when the pressed portion 20e moves away from the pressing portion 18a and the recess portion 20g reaches the position of the pressing portion 18a, the supporting portion 20a is warped to a side opposite to the side of the sealing portion 20b by an elastic reaction force of the sealing portion 20b. With this, on an inner side in the longitudinal direction, the pressure of the sealing portion 20b that biases the surrounding part of the opening 17a in the first frame 17 is reduced and, as a result, the unsealing load is reduced. The sealing unit 20 receives the drive from the image forming apparatus main body B and, as illustrated in FIG. 6D, rotates by a predetermined angle θ1 (hereinafter referred to as an unsealing angle) in the direction of the arrow R in the drawing to move to a second position from a first position illustrated in FIG. 6B. Consequently, with the rotation of the sealing unit 20, a state of the sealing unit 20 can change from the first state in which the sealing unit 20 seals the opening 17a to the second state in which the sealing unit 20 opens the opening 17a. With this operation, the unsealing operation of the sealing unit 20 is performed. As illustrated in FIG. 6D, in the second state in which the sealing unit 20 opens the opening 17a, at least part of the pressing portion 18a is positioned in the depressed portion of the pressed portion 20e, and a gap is formed between the inner surface of the depressed portion (the recess portion 20g) and the pressing portion 18a. That is, when the sealing unit 20 is in the unsealing state, the gap is formed between the inner surface of the depressed portion (the recess portion 20g) and the pressing portion 18a. In addition, the sealing portion 20b has elasticity, and hence, as illustrated in FIG. 6D, the pressed portion 20e is separated from the pressing portion 18a, and the shapes of the lips 20b1 to 20b4 return to original states before the deformation from deformed states.

Further, the sealing unit 20 does not remain at the second position and, as illustrated in FIG. 6E, rotates by a second predetermined angle θ2 (hereinafter referred to as a maximum angle) in the direction of the arrow R in the drawing from the first position to move to a third position where the sealing unit 20 does not come into contact with the pressing portion 18a. Immediately after that, the sealing unit 20 reversely rotates in a direction of an arrow C in FIG. 6E to return to the second position illustrated in FIG. 6D. Thereafter, similarly, the sealing unit 20 continuously performs back-and-forth movement between the second position and the third position. In the embodiment, the driving structure is set such that the unsealing angle θ1 is 77 degrees, and the maximum angle θ2 is 95 degrees. The above operation of the sealing unit 20 can be implemented by using, e.g., a link mechanism or the like. However, in the embodiment, the above operation of the sealing unit 20 is implemented by using a partially toothed gear and a spring. The unsealing angle θ1 and the maximum angle θ2 can be freely set according to specifications of the gear. The detail of the driving structure will be described later.

Incidentally, as illustrated in FIG. 5A, in the supporting portion 20a, a plurality of ribs 20f are provided at positions opposite to the position of the sealing portion 20b. As illustrated in FIG. 5A, the ribs 20f are inclined 45 degrees with respect to the axis g joining the shaft portions 20c and 20d. In addition, the plurality of ribs 20f are disposed such that the inclination direction of the rib 20f on one side of the center of the sealing unit 20 in the longitudinal direction is different from the inclination direction of the rib 20f on the other side thereof. The ribs 20f are inclined toward the outer side of the sealing unit 20 in the longitudinal direction with approach to the downstream side from the upstream side in the rotation direction R of the sealing unit 20. By disposing the ribs 20f in this manner, when the sealing unit 20 is positioned between the second position and the third position, the ribs 20f are inclined toward the inner side of the sealing unit 20 in the longitudinal direction with approach to a lower side from an upper side in the direction of gravity. With the configuration of the ribs 20f, the sealing unit 20 performs the back-and-forth movement between the second position and the third position, and it is thereby possible to gently gather the toner at the center of the sealing unit 20 in the longitudinal direction while stirring the toner in the developer accommodating chamber 26. Accordingly, for example, even in the case where the toner is unevenly present at one end of the sealing unit 20 in the longitudinal direction, it is possible to quickly move the toner to the center of the sealing unit 20 in the longitudinal direction, and hence it is possible to reduce idling time before image output.

In addition, in the embodiment, the sealing unit 20 performs the back-and-forth movement after the opening (unsealing), whereby the sealing unit 20 is allowed to have stirring function. For example, in the case where the sealing unit 20 performs rotary motion, the sealing unit 20 interferes with the pressing portion 18a. Consequently, in the case where the sealing unit 20 performs the rotary motion, sealing that uses welding is required. That is, in the case where sealing means having stirring function is automatically opened in an apparatus main body, it is common to adopt a configuration in which a film is welded around an opening in a frame, and the film is wound around a shaft provided in the frame to be peeled. However, according to the embodiment, it is possible to implement the sealing unit 20 having the stirring function that does not require welding. In addition, in the embodiment, the unsealing is performed by moving the biasing sealing portion 20b, and hence the unsealing load can be made lower than the unsealing load in the case where a welded member is peeled (i.e., mechanically destroyed).

In addition, in the case of the sealing that uses the welding, it is necessary to form a welding surface, i.e., a surface around the opening into a flat surface for welding stability. However, the configuration of the embodiment does not have such restriction, and hence it is possible to form the surface around the opening 17a into an inclined shape or arc shape that is directed downward in the direction of gravity toward the opening 17a. With this, the fall of the toner around the opening 17a into the opening 17a is facilitated and, as compared with the conventional welding sealing configuration, discharge performance is improved in the configuration of the embodiment.

In addition, as illustrated in FIG. 6B, the rotation center g of the sealing unit 20 is provided at a position that is offset about 2 mm to the upstream side (the right side in the drawing) in the direction of movement of the sealing portion 20b at the time of the start of the unsealing with respect to the arc center h of the contacted portion 17d. With this configuration, when the unsealing is performed, while the lips 20b3 and 20b4 disposed on the short sides of the base portion 20b0 (see FIG. 5A and FIG. 5B) gradually move away from the contacted portion 17d in the radial direction of the arc of the contacted portion 17d, the sealing portion 20b moves. In the case where the arc center h matches the rotation center g (hereinafter referred to as a concentric configuration), the sealing portion 20b continuously slides on and rubs against the bottom surface of the first frame 17 in the unsealing operation, and hence a state in which unsealing torque is high is continued. According to the configuration of the embodiment, a frictional load is gradually reduced from the start of the unsealing, and hence it is possible to gradually reduce the unsealing torque from the start of the unsealing as compared with the concentric configuration. In addition, by using a disposition in which the arc center h is displaced from the rotation center g, it is possible to move the sealing unit 20 that performs the back-and-forth movement between the second position and the third position in the direction of the radius of rotation K with respect to the bottom surface of the first frame 17. Accordingly, it is possible to provide a wide gap d (FIG. 6D) between the sealing unit 20 and the bottom surface of the first frame 17. As a result, the toner in the developer accommodating chamber 26 can be smoothly discharged from the opening 17a to the outside without being obstructed by the sealing unit 20. In addition, in the configuration of the embodiment, the stress of the toner can be reduced to a level lower than that in the configuration in which the sealing portion 20b slides on and rubs against the inner surface of the first frame 17. On the other hand, in the case of the concentric configuration, the lip 20b2 on the upstream side in the rotation direction R moves to the contacted portion 17b on the upstream side in the rotation direction R, and the sealing unit 20 can be thereby spaced from the bottom surface of the first frame 17. That is, in order to provide the gap d between the sealing unit 20 and the bottom surface of the first frame 17, it is necessary to cause the sealing unit 20 to further rotate beyond the second position in the rotation direction R.

Driving Structure of Sealing Unit 20

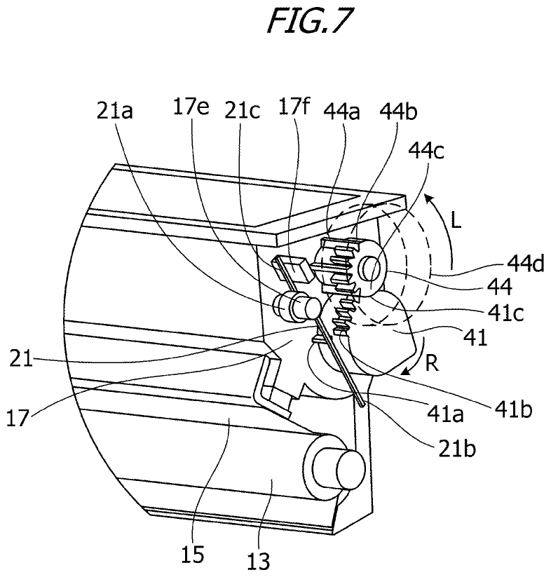

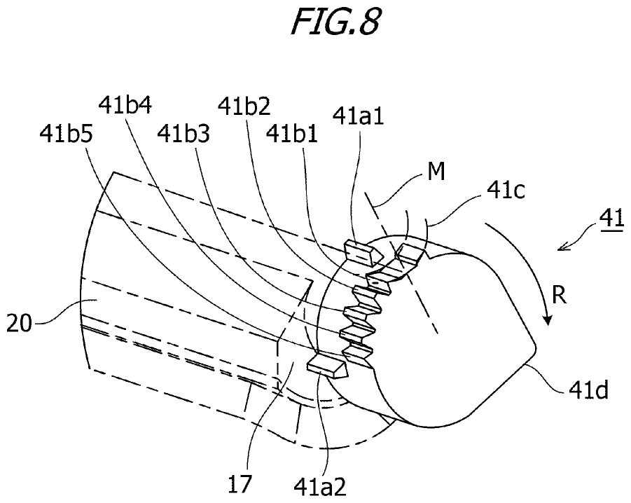

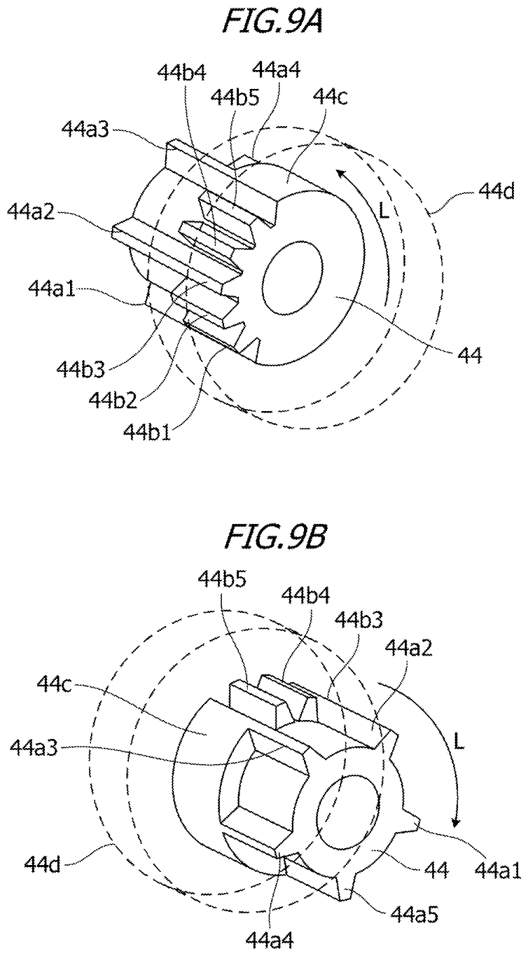

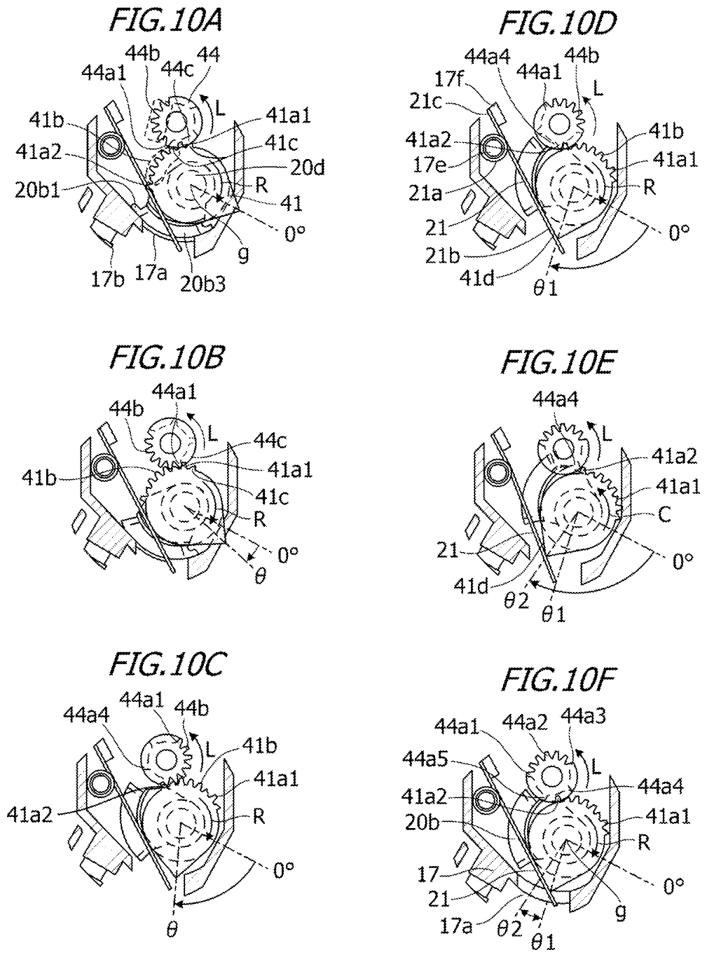

Next, the operation of the sealing unit 20 will be described by using FIG. 7, FIG. 8, FIGS. 9A and 9B, and FIGS. 10A to 10F. FIG. 7 is a perspective view illustrating a driving portion of the sealing unit 20, and FIG. 8 is a perspective view illustrating the unsealing gear 41. FIG. 9A is a perspective view illustrating the intermediate gear 44, and FIG. 9B is a perspective view when the intermediate gear 44 is viewed from a direction opposite to the direction in FIG. 9A. Each of FIGS. 10A to 10F is a view for explaining the operation of the sealing unit 20, and the sealing unit 20 operates in the order of FIG. 10A to FIG. 10F.

As illustrated in FIG. 7, the unsealing gear 41 coupled to the sealing unit 20 is provided at an outer end portion of the first frame 17 in the longitudinal direction. In addition, as illustrated in FIG. 8, a multi-stage gear constituted by a first unsealing gear portion 41a (41a1 and 41a2) and a second unsealing gear portion 41b (41b1 to 41b5) is disposed. The first unsealing gear portion 41a is closer to the first frame 17 than the second unsealing gear portion 41b. As illustrated in FIG. 8, the first unsealing gear portion 41a is a partially toothed gear in which, of all twenty-eight teeth of the gear, two teeth (41a1 and 41a2) that are disposed at an interval corresponding to five teeth remain, and the other teeth are removed. On the other hand, the second unsealing gear portion 41b is a partially toothed gear in which, of all twenty-eight teeth of the gear, five teeth (41b1 to 41b5) that are continuously disposed remain, and the other teeth are removed. The continuously disposed five teeth of the second unsealing gear portion 41b are provided between the two teeth of the first unsealing gear portion 41a. In addition, an arc-shaped depressed portion 41c is disposed on the downstream side in the rotation direction R of the second unsealing gear portion 41b. As illustrated in FIG. 8, when viewed from the longitudinal direction, the center of one tooth (hereinafter referred to as a tip tooth) 41a1 on the downstream side in the rotation direction R of the first unsealing gear portion 41a is positioned on a line M that joins the arc center of the arc-shaped depressed portion 41c and the rotation center of the unsealing gear 41. In the embodiment, part of the center of the arc-shaped depressed portion 41c is retracted to conform to the bottom arc of the second unsealing gear portion 41b. Part of the center of the arc-shaped depressed portion 41c is retracted in order to simplify the mold structure of the unsealing gear 41 and, as long as arc shapes are provided at both ends of the tip tooth 41a1 when viewed from the longitudinal direction, any functional problem does not arise, as will be described later.

As illustrated in FIG. 9A and FIG. 9B, the intermediate gear 44 that engages the unsealing gear 41 also has the multi-stage gear configuration. There are provided a first intermediate gear portion 44a (44a1 to 44a5) and a second intermediate gear portion 44b (44b1 to 44b5) that engage the first unsealing gear portion 41a and the second unsealing gear portion 41b respectively, and a third intermediate gear portion 44d that engages the input gear 43 that is not illustrated. The third intermediate gear portion 44d is a typical fully toothed gear. In order to facilitate understanding of the first intermediate gear portion 44a and the second intermediate gear portion 44b, the third intermediate gear portion 44d is indicated by a broken line in FIG. 9A and FIG. 9B. The first intermediate gear portion 44a is a partially toothed gear in which, of all fifteen teeth of the gear, five teeth (44a1 to 44a5) that are disposed at regular intervals each corresponding to two teeth remain, and the other teeth are removed. The second intermediate gear portion 44b is a partially toothed gear in which, of all fifteen teeth of the gear, continuously disposed five teeth remain, and the remaining periphery of the gear is formed of an arc portion 44c having the same outer diameter as that of a tip circle.

Next, the operation of the sealing unit 20 when the input gear 43 receives rotational drive from the image forming apparatus main body B and rotates will be described by using FIGS. 10A to 10F. In FIGS. 10A to 10F, in order to facilitate understanding, the depiction of the third intermediate gear portion 44d is omitted. As illustrated in FIG. 10A, in the case where the sealing unit 20 is in the sealing state, the arc-shaped depressed portion 41c of the unsealing gear 41 engages the arc portion 44c of the intermediate gear 44. When the intermediate gear 44 receives the rotational drive of the input gear 43 that is not illustrated and rotates in a direction of an arrow L, first, one tooth 44a1 of the first intermediate gear portion 44a disposed on the upstream side in the rotation direction L of the arc portion 44c transmits the rotational drive to the tip tooth 41a1 disposed on the upstream side in the rotation direction R of the arc-shaped depressed portion 41c. Subsequently, the unsealing gear 41 starts to rotate in the direction of the arrow R. Correspondingly, as illustrated in FIG. 10B and FIG. 10C, the teeth of the second intermediate gear portion 44b sequentially engage the corresponding teeth of the second unsealing gear portion 41b, and the unsealing gear 41 is thereby caused to rotate. At the time of the sealing state, as described above, the first intermediate gear portion 44a has the intervals each corresponding to two teeth. On the other hand, the arc-shaped depressed portion 41c of the unsealing gear 41 is engaged with the arc portion 44c of the intermediate gear 44, and hence the rotational drive does not propagate reversely to the upstream side (opposite side) from the sealing unit 20. That is, with the lock mechanism described above, it is possible to prevent the sealing unit 20 from rotating by mistake due to vibrations or the like during distribution.

FIG. 10D illustrates a state in which the engagement between the second intermediate gear portion 44b and the second unsealing gear portion 41b is completed. The sealing unit 20 rotates by the unsealing angle θ1 in the direction of the arrow R in FIG. 10D to move from the first position in the sealing state to the second position, and the unsealing is completed. In this case, a biasing spring 21 provided in the first frame 17 comes into contact with a biased portion 41d of the unsealing gear 41. The biasing spring 21 is a helical torsion spring, and a winding portion 21a is engaged with a boss 17e disposed on the side surface of the first frame 17. The biasing spring 21 is disposed such that one arm portion 21b comes into contact with the biased portion 41d of the unsealing gear 41, and the other arm portion 21c comes into contact with a regulating rib 17f of the first frame 17. In this state, the biased portion 41d is formed to be parallel to the arm portion 21b. With this, the unsealing gear 41 does not rotate from this phase in a direction opposite to the direction of the arrow R. That is, the sealing unit 20 that has once moved to the second position does not move in the direction of the first position again. Consequently, after a state of the sealing unit 20 has changed from the sealing state to the unsealing state, the state of the sealing unit 20 does not change from the unsealing state to the sealing state. When the intermediate gear 44 further rotates in the direction of the arrow L, one tooth 44a4 of the first intermediate gear portion 44a transmits the drive to the other tooth 41a2 (hereinafter referred to as an end tooth) of the first unsealing gear portion 41a that does not contribute to the unsealing, and the unsealing gear 41 further rotates in the direction of the arrow R. In this case, the biasing spring 21 operates to prevent the unsealing gear 41 from rotating in the direction of the arrow R. After the unsealing gear 41 has rotated in the direction of the arrow R by a distance corresponding to one tooth from the state in FIG. 10D, the transmission of the drive from the intermediate gear 44 is stopped because the first intermediate gear portion 44a is the partially toothed gear.

As illustrated in FIG. 10E, the unsealing gear 41 is caused to rotate in a direction of an arrow C in the drawing by the biasing spring 21, and returns to the position in FIG. 10D. The position (the third position) of the sealing unit 20 at the moment when the transmission of the drive from the intermediate gear 44 is stopped is the position spaced from the first position in the sealing state by a distance corresponding to the maximum angle θ2 in the direction of the arrow R. As illustrated in FIG. 10F the intermediate gear 44 continuously rotates in the direction of the arrow L thereafter. One tooth 44a5 on the upstream side of one tooth 44a4 in the rotation direction L of the first intermediate gear portion 44a having driven the unsealing gear 41 from the second position to the third position comes into contact with the end tooth 41a2, and the unsealing gear 41 starts to rotate in the direction of the arrow R again. Thus, the first intermediate gear portion 44a repeats the intermittent contact with the end tooth 41a2 of the unsealing gear 41, whereby the sealing unit 20 repeats the back-and-forth movement between the second position and the third position. Thus, it is possible to implement the unsealing operation and the stirring operation by using the simple component configuration having a pair of the partially toothed gears and the spring. In addition, by using the driving structure according to the embodiment, movement start acceleration in a direction in which the sealing unit 20 returns from the third position to the second position using the biasing spring 21 is higher than movement start acceleration in a direction in which the sealing unit 20 moves from the second position to the third position using the uear. By providing a difference in movement start acceleration in the back-and-forth movement of the sealing unit 20 in this manner, toner adhering to the sealing unit 20 is shaken off, and hence it is possible to use a larger amount of toner in the developer accommodating chamber 26.

According to the present invention, it is possible to improve the sealing performance while reducing the unsealing load of the compressed seal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2018-143129, filed on Jul. 31, 2018, and Japanese Patent Application No. 2018-143154, filed on Jul. 31, 2018, which are hereby incorporated by reference herein in their entirety.

What is claimed is:

1. A developer accommodating unit comprising:
a frame provided with a developer accommodating chamber configured to accommodate a developer, and an opening for discharging the developer from the developer accommodating chamber; and
a sealing unit provided inside the frame, the sealing unit including a supporting portion rotatable in a first direction, and a sealing portion attached to the supporting portion, the sealing portion sealing the opening, the sealing portion having a protruding portion including a first part, the protruding portion being capable of coming into contact with the frame in a surrounding part of the opening, a state of the sealing unit being capable of changing from a first state in which the sealing portion seals the opening to a second state in which the opening is opened,
wherein if the sealing unit is in the first state, a tip of the first part is positioned on a downstream side of a base of the first part in the first direction, and
wherein if the state of the sealing unit changes from the first state to the second state, the first part is deformed such that the tip of the first part is positioned on an upstream side of the base of the first part in the first direction.

2. The developer accommodating unit according to claim 1,
wherein the sealing portion seals the opening by being compressed by the frame and the supporting portion.

3. The developer accommodating unit according to claim 1,
wherein if the sealing unit is in the first state, the first part comes into contact with the frame on a downstream side of the opening in the first direction.

4. The developer accommodating unit according to claim 1,
wherein the protruding portion includes a second part, and
wherein if the sealing unit is in the first state, a tip of the second part is positioned on an upstream side of a base of the second part in the first direction.

5. The developer accommodating unit according to claim 4,
wherein if the state of the sealing unit changes from the first state to the second state, the tip of the second part is positioned on the upstream side of the base of the second part in the first direction.

6. The developer accommodating unit according to claim 1, further comprising:
a pressing portion provided inside the frame; and
a pressed portion provided in the sealing unit, the pressed portion coming into contact with the pressing portion if the sealing unit is in the first state.

7. The developer accommodating unit according to claim 6,
wherein the sealing unit has a recess portion that is provided within a radius of rotation of the pressed portion, and
if the sealing unit is in the second state, at least part of the pressing portion is positioned in the recess portion, and a gap is formed between an inner surface of the recess portion and the pressing portion.

8. The developer accommodating unit according to claim 6,
wherein the pressing portion is disposed at a position facing the opening.

9. The developer accommodating unit according to claim 1,
wherein the state of the sealing unit does not change from the second state to the first state after the state of the sealing unit has changed from the first state to the second state.

10. A process cartridge detachably provided in a main body of an image forming apparatus for performing image formation, the process cartridge comprising:
the developer accommodating unit according to claim 1; and
an image bearing member configured to bear a developer image.

11. An image forming apparatus configured to perform image formation comprising:
the developer accommodating unit according to claim 1;
an image bearing member configured to bear a developer image; and
a transfer portion configured to transfer the developer image borne by the image bearing member to a recording material.

12. A developer accommodating unit comprising:
a frame provided with a developer accommodating chamber configured to accommodate a developer, and an opening for discharging the developer from the developer accommodating chamber; and
a sealing unit provided inside the frame, the sealing unit including a supporting portion rotatable in a first direction, and a sealing portion attached to the supporting portion, the sealing portion sealing the opening by being compressed by the frame and the supporting portion, the sealing portion having a protruding portion including a first part and a second part, the protruding portion being capable of coming into contact with the frame in a surrounding part of the opening, a state of the sealing unit being capable of changing from a first state in which the sealing portion seals the opening to a second state in which the opening is opened,
wherein if the sealing unit is in the first state, the first part comes into contact with the frame on a downstream side of the opening in the first direction and is inclined from a base of the first part toward a tip of the first part in a direction from an upstream side of the opening toward the downstream side of the opening, and the second part comes into contact with the frame on the upstream side of the opening in the first direction and is inclined from a base of the second part toward a tip of the second part in a direction from the downstream side of the opening toward the upstream side of the opening, and
a length from the base of the first part to the tip of the first part is greater than a thickness of the first part, and a length from the base of the second part to the tip of the second part is greater than a thickness of the second part when viewed in a direction of a rotational axis of the supporting portion.

13. The developer accommodating unit according to claim 12,
wherein if the sealing unit is in the first state, part of an inner surface of the first part comes into contact with the frame on the downstream side of the opening in the first direction, and part of an inner surface of the second part comes into contact with the frame on the upstream side of the opening in the first direction.

14. The developer accommodating unit according to claim 12, further comprising:
a pressing portion provided inside the frame; and
a pressed portion provided in the sealing unit, the pressed portion coming into contact with the pressing portion if the sealing unit is in the first state.

15. The developer accommodating unit according to claim 14,
wherein the protruding portion has elasticity,
if the sealing unit is in the first state, the first part comes into contact with the frame on the downstream side of the opening in a state in which the first part is deformed and the second part comes into contact with the frame on the upstream side of the opening in a state in which the second part is deformed, and
if the sealing unit is in the second state, the pressed portion is separated from the pressing portion, the first part returns to an original shape, and the second part returns to an original shape.

16. The developer accommodating unit according to claim 14,
wherein a concave shape is formed on a surface of the pressed portion that is in contact with the pressing portion, and a convex shape is formed on a surface of the pressing portion that is in contact with the pressed portion.

17. The developer accommodating unit according to claim 14,
wherein the sealing unit has a recess portion that is provided within a radius of rotation of the pressed portion, and
a gap is formed between an inner surface of the recess portion and the pressing portion if the sealing unit is in the second state.

18. The developer accommodating unit according to claim 12,
wherein rigidity of the sealing portion is lower than rigidity of the supporting portion.

19. The developer accommodating unit according to claim 12,
wherein the supporting portion, the sealing portion, and the protruding portion are integrally formed.

20. A process cartridge detachably provided in a main body of an image forming apparatus for performing image formation, the process cartridge comprising:
the developer accommodating unit according to claim 12; and
an image bearing member configured to bear a developer image.

21. An image forming apparatus configured to perform image formation comprising:
the developer accommodating unit according to claim 12;
an image bearing member configured to bear a developer image; and
a transfer portion configured to transfer the developer image borne by the image bearing member to a recording material.
